(19) United States
(12) Patent Application Publication
(10) Pub. No.: US 2009/0204525 A1
(43) Pub. Date: Aug. 13, 2009

(54) PAYMENT DEVICE TO ISSUER COMMUNICATION VIA AUTHORIZATION REQUEST

(76) Inventor: Simon Phillips, York (GB)

Correspondence Address: BUCKLEY, MASCHOFF & TALWALKAR LLC, 50 LOCUST AVENUE, NEW CANAAN, CT, 06840, US

(21) Appl. No.: 12/030,500

(22) Filed: Feb. 13, 2008

(51) Int. Cl. G06Q 40/00

(52) U.S. Cl. 705/35

(57) ABSTRACT

A method includes receiving a transaction authorization request in a server computer. The transaction authorization request is for the purpose of authorizing a payment card account transaction. The method further includes parsing the discretionary data field defined in the transaction authorization request, to receive information regarding a payment device that initiated the payment card account transaction.

### BACKGROUND

Payment cards such as credit or debit cards are ubiquitous. For decades, such cards have included a magnetic stripe on which the relevant account number is stored. To consummate a purchase transaction with such a card, the card is swiped through a magnetic stripe reader that is part of a point of sale (POS) terminal. The reader reads the account number from the magnetic stripe. The account number is then used to route a transaction authorization request that is initiated by the POS terminal.

There is a standardized data storage format for the magnetic stripes of credit and debit cards. The standardized format includes format definitions for two magnetic data storage tracks, referred to as “Track 1” and Track 2”. Both Track 1 and Track 2 formats include fields for the payment card account number and for the card expiration date. Both formats also include a field for “discretionary data”. The Track 1 discretionary data field has space for 26 characters of data; the Track 2 discretionary data field has space for 13 characters. Traditionally, the issuer financial institution was permitted to include any data it wished in the discretionary data field. A common use for the discretionary data field has been to contain a security code such as the “Card Verification Code” (CVC) prescribed by MasterCard International Inc. (which is the assignee hereof).

In pursuit of still greater convenience and more rapid transactions at POS terminals, payment cards have more recently been developed that allow the account number to be automatically read from the card by radio frequency communication between the card and a so-called “proximity reader” or “contactless reader” which may be incorporated with the POS terminal. In such cards, often referred to as “proximity payment cards” or “contactless payment cards”, a radio frequency identification (RFID) integrated circuit (IC, often referred to as a “chip”) is embedded in the card body. A suitable antenna is also embedded in the card body and is connected to the RFID chip to allow the chip to receive and transmit data by RF communication via the antenna. In typical arrangements, the RFID chip is powered from an interrogation signal that is transmitted by the contactless reader and received by the card antenna.

MasterCard International Incorporated, the assignee hereof, has established a widely-used standard, known as “PayPass”, for interoperability of contactless payment cards and contactless readers.

PayPass is not the only standard that has been established for contactless payment operations. For example, American Express has established a contactless payment communications standard that is called “ExpressPay”, and Amex has issued contactless payment cards in its name that operate in accordance with the ExpressPay standard. Other contactless payment communication standards have also been established.

Although contactless payment cards communicate wirelessly with POS terminals, the format in which contactless payment cards upload information to the POS terminals continues to reflect the conventional “Track 1” and/or “Track 2” data format originally promulgated for magnetic stripe payment cards. Accordingly, the data format used in the uploading of data from contactless payment card to POS terminal continues to include a discretionary data field. It remains a conventional practice to include a security code in the discretionary data field. For example, the security code may be a fixed value stored in the contactless payment card (sometimes referred to as a “CVC2”), or alternatively, the security code may be cryptographically generated by the contactless payment card for each transaction, as described, for example, in a paper entitled “PayPass Information Paper: ATC Regeneration and Tracking” (Version 1.4) published by MasterCard International Inc. on Oct. 26, 2004. The latter type of security code is sometimes referred to as a “CVC3”, or as a “dynamic” CVC.

It has also been proposed to provide proximity payment devices in form factors other than in the shape of conventional payment cards. For example, there have been proposals to equip consumer devices, such as mobile telephones, with proximity payment capabilities. For payment purposes, it is contemplated that such devices would substantially identically duplicate the functionality of proximity payment cards, as described above. For example, a payment-capable mobile telephone may be equipped with capabilities for short-range wireless communications, such as in accordance with the well-known NFC standard. The format in which a payment-capable mobile telephone uploads information to a POS terminal typically would be the same as the data format employed by a contactless payment card.

One issue associated with proposals for payment-capable mobile telephones is how to provide such devices with a payment account number and/or other information to allow the device to operate as a proximity payment device. There have been proposals to transmit a payment account number and/or other information to mobile telephones via the cellular network. This proposed technique is referred to as “over the air” (OTA) personalization. It has alternatively been proposed—in co-pending, commonly-assigned U.S. patent application Ser. No. 11/870,144, filed Oct. 10, 2007 (such application being incorporated herein by reference)—that a mobile telephone or other device be personalized for payment applications by causing the device to wirelessly interact with another device in the shape of a payment card, from which personalization information is downloaded to the first device. The latter type of device may be referred to as a “personalization card”. In conjunction with either OTA personalization or personalization via personalization card, it may also be necessary or desirable to load a suitable payment application program into the prospective proximity payment device.

It may in many cases be desirable for the issuer financial institution to be made aware that personalization has occurred with respect to a mobile telephone or other consumer device that is payment-capable. At least in the case of a mobile telephone, it could be contemplated to have the device automatically report its personalization by a message to the issuer via the mobile telephone network. However, one disadvantage of such an approach would be the expense and effort required for the issuer to set up a facility to receive such messages.

The present inventor has now recognized that the discretionary data field included in uploads of information from proximity payment devices to POS terminals in connection with purchase transactions provides a potential channel for communication from the proximity payment devices to the issuers of the corresponding payment accounts. This potential communication channel may be used to report personalization of the proximity payment devices or to report other information about the proximity payment devices.

### BRIEF DESCRIPTION OF THE DRAWINGS

FIG. 1 is a schematic representation of personalization of a proximity payment device.

FIG. 2 is a block diagram that illustrates a payment system in which the present invention may be applied.

FIG. 3 is a block diagram representation of an example of a mobile telephone such as that depicted in FIGS. 1 and 2.

FIG. 4 is a block diagram representation of a server computer that is included in the payment system of FIG. 2.

FIG. 5 is a flow chart that illustrates a process that may be performed, in accordance with aspects of the present invention, in a proximity payment device that is part of the system of FIG. 2.

FIG. 6 is a flow chart that illustrates a process that may be performed, in accordance with aspects of the present invention, in a server computer that is part of the system of FIG. 2.

### DETAILED DESCRIPTION

In general, and for the purpose of introducing concepts of embodiments of the present invention, a mobile telephone or other device with proximity payment capabilities uploads information about itself to a POS terminal as part of a purchase transaction. The information may confirm that the proximity payment device has been personalized or may indicate other attributes of the device, such as make, model number, version of current operating system, available memory space for payment applications, etc. The information may be inserted in a Track 1 or Track 2 discretionary data field so that the information is included in an authorization request that is initiated by the POS terminal and routed through the payment system to the issuer of the payment card account that is accessed by the proximity payment device. The information may replace or be in addition to a security code (e.g., CVC2or CVC3) customarily uploaded from the proximity payment device to the POS terminal during a purchase transaction.

Upon receiving the authorization request, the issuer's server computer parses the discretionary data in the authorization request to read the information that the proximity payment device uploaded about itself. Accordingly, the discretionary data field is used, in conjunction with an otherwise conventional authorization request through the payment system, as a channel of communication from the proximity payment device to the issuer. As a result, the issuer may receive information from proximity payment devices without incurring the costs associated with establishing an infrastructure for receiving communications via a mobile network. Moreover, the use of the discretionary data field as a communication channel also permits communication to the issuer from proximity payment devices such as MP3 players that may not have network communication capabilities.

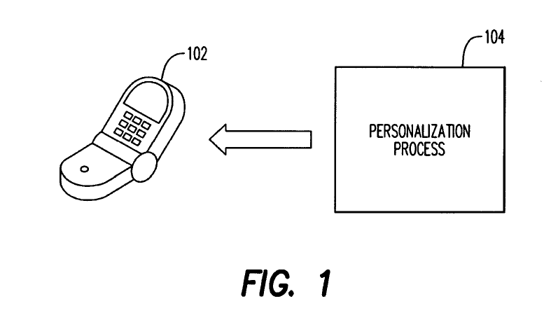

FIG. 1 is a schematic representation of personalization of a proximity payment device. Reference numeral 102 indicates a mobile telephone that is being personalized so that it may function as a proximity payment device. Block 104 represents a personalization process that is applied to the mobile telephone 102. The personalization process 104 may be OTA, or via a personalization card, or via a kiosk, or via any other technique proposed previously or in the future. At a minimum, “personalization” refers to loading a payment card account number into the mobile telephone (or other device) such that the payment card account number may subsequently be uploaded from the device to a POS terminal as part of a purchase transaction utilizing a payment system. In addition, the personalization process 104 may include loading other information into the mobile telephone or other device. The other information may include the user's name and a security code to be permanently stored in the device and/or data to be used by the device for generating a dynamic security code in connection with each transaction. Still further, the personalization process may include loading a payment application program into the device.

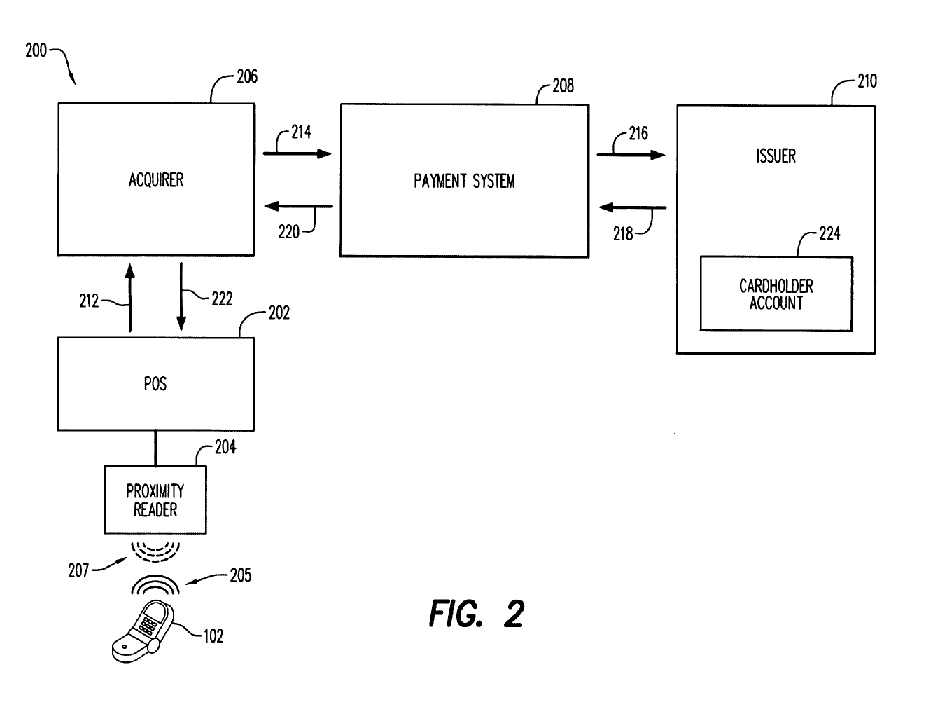

FIG. 2 is a block diagram that illustrates a payment system 200 in which the present invention may be applied.

To initiate a purchase transaction in the payment system 200, a customer (not shown) visits a retail store (not shown) operated by a merchant, selects goods (not shown) that he/she wishes to purchase, carries the goods to the merchant's point of sale terminal 202, and presents his/her proximity payment device (assumed in this case to be the mobile telephone 102) to the point of sale terminal 202 via a proximity reader 204 that is part of or associated with the POS terminal 202. The POS terminal 202 reads the customer's payment card account number from the mobile telephone 102. That is, the mobile telephone uploads the payment card account number to the proximity reader 204/POS terminal 202 via a transmission 205 in response to one or more interrogation signals 207 from the proximity reader 204. The POS terminal 204 then sends an authorization request to an acquirer financial institution (FI) 206 with which the merchant has a relationship. The authorization request includes the payment card account number and the amount of the transaction, among other information. The authorization request is routed via a payment card system 208 (which may be, for example, the well-known Banknet system operated by the assignee hereof) to the issuer financial institution 210 that issued the customer's payment card account. Arrows 212, 214 and 216 trace the path of the authorization request from the POS terminal 202 to the issuer 210.

Assuming that all is in order, the issuer FI 210 transmits a favorable authorization response to the POS terminal 202 through the payment card system 208 and via the acquirer FI 206. (The path of the authorization response from the issuer FI 210 to the POS terminal 202 is traced by arrows 218, 220, 222.) The transaction at the POS terminal 202 is then completed and the customer leaves the store with the goods.

A subsequent clearing transaction initiated by the merchant results in a transfer of the transaction amount from the customer's payment card account 224 to an account that belongs to the merchant (in practice, the amount received by the merchant may be net of service fees). The customer's payment card account 224 may be, for example, either a debit card account or a credit card account. In the former case, the clearing transaction results in the funds being debited directly from the account 224. In the latter case, the clearing transaction results in a charge being posted against the account 224, and the charge subsequently appears on the customer's monthly credit card statement.

The foregoing description of the typical transaction may be considered to be somewhat simplified in some respects. For example, a so-called merchant processing system (not shown) may be interposed between the POS terminal and the acquirer FI. As is familiar to those who are skilled in the art, a merchant processing system may be operated by or on behalf of the merchant to form part of the communications path between the acquirer FI and a considerable number of POS terminals operated by the merchant. It is also often the case that a third party transaction processing service may operate to handle payment card transactions on behalf of the acquirer and on behalf of a large number of other like financial institutions.

Up to this point, the description of FIG. 2 has included only conventional aspects of a payment card account purchase transaction. However, subsequent discussion will set forth further aspects of a purchase transaction, which may take place in accordance with aspects of the present invention.

It should be noted that blocks 206, 208 and 210, in addition to representing respective entities in the payment system 200, may also be considered to represent server computers and/or other computers or computer systems operated by or on behalf of the respective entities.

Although only one acquirer, one issuer, and one POS terminal are shown in FIG. 2 (in that only a single transaction is depicted therein), in practice the payment system 200 may comprise numerous POS terminals, numerous acquirers and numerous issuers.

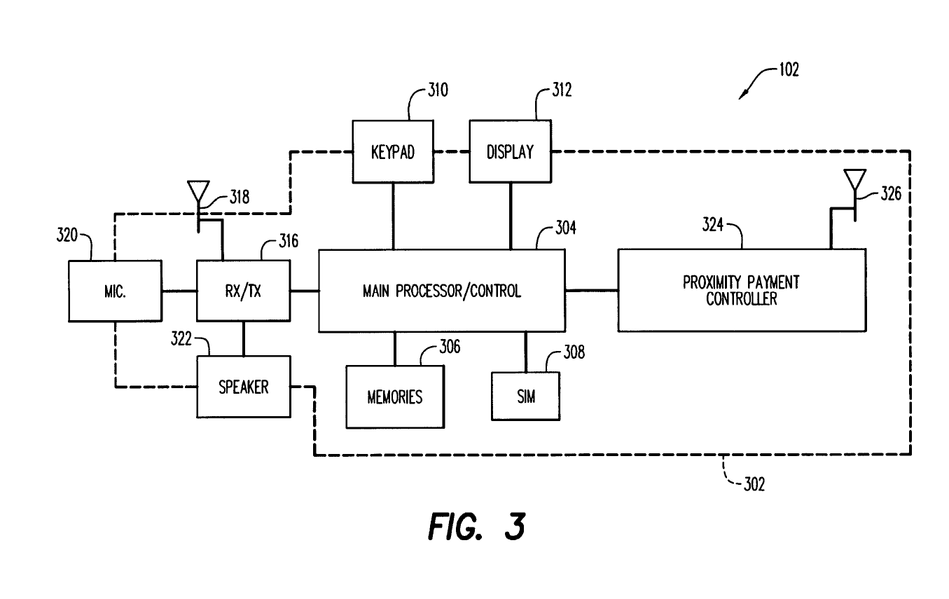

FIG. 3 is a block diagram representation of an example of the mobile telephone 102. (FIG. 3 does not necessarily represent the physical layout of the mobile telephone 102.) In its hardware aspects, and in its functioning as a mobile communication device, the mobile telephone 102 may be entirely conventional.

The mobile telephone 102 may include a conventional housing (indicated by dashed line 302 in FIG. 3) that contains and/or supports the other components of the mobile telephone 102. The mobile telephone 102 further includes conventional control circuitry 304, for controlling over-all operation of the mobile telephone 102. Other components of the mobile telephone 102, which are in communication with and/or controlled by the control circuitry 304, include: (a) one or more memory devices 306 (e.g., program and working memory, etc.); (b) a conventional SIM (subscriber identification module) card 308; (c) a conventional keypad 310 for receiving user input; and (d) a conventional display 312 for displaying output information to the user.

The mobile telephone 102 also includes conventional receive/transmit circuitry 316 that is also in communication with and/or controlled by the control circuitry 304. The receive/transmit circuitry 316 is coupled to an antenna 318 and provides the communication channel(s) by which the mobile telephone 102 communicates via the mobile network (not shown). The mobile telephone 102 further includes a conventional microphone 320, coupled to the receive/transmit circuitry 316. Of course, the microphone 320 is for receiving voice input from the user. In addition, a loudspeaker 322 is included to provide sound output to the user, and is coupled to the receive/transmit circuitry 316.

In conventional fashion, the receive/transmit circuitry 316 operates to transmit, via the antenna 318, voice signals generated by the microphone 320, and operates to reproduce, via the loudspeaker 322, voice signals received via the antenna 318. The receive/transmit circuitry 316 may also handle transmission and reception of text messages and/or other data communications via the antenna 318.

The mobile telephone 102 may also include an integrated circuit (IC) or chipset 324 of the kind embedded in contactless payment cards. The IC/chipset 324 may also be referred to as a “payment circuit”. The payment circuit 324 may include a processor/controller circuit (not separately shown) and program and/or working memory (not separately shown) in communication with the processor/controller circuit. The program memory may store software, including an application program, that controls operation of the processor/controller circuit to provide functionality as described herein.

In some embodiments, the payment circuit 324 may be partially or entirely integrated with main processor/control circuit 304 and/or with memories 306.

The payment circuit 324 may store a payment card account number that identifies a payment card account that has been issued to the individual who owns the mobile telephone 102. Further, the mobile telephone 102 may include an antenna 326 that is coupled to the payment circuit 324 to permit the payment circuit 324 to exchange wireless communications with POS terminals in connection with payment card system purchase transactions. That is, the payment circuit 324 may operate so as to interact with an RFID/NFC proximity reader of a POS terminal to provide the payment card account number (stored in the payment circuit 324) for a purchase transaction at the POS terminal. For example, the payment circuit 324 may be designed/programmed to operate in accordance with the above-mentioned “PayPass” standard.

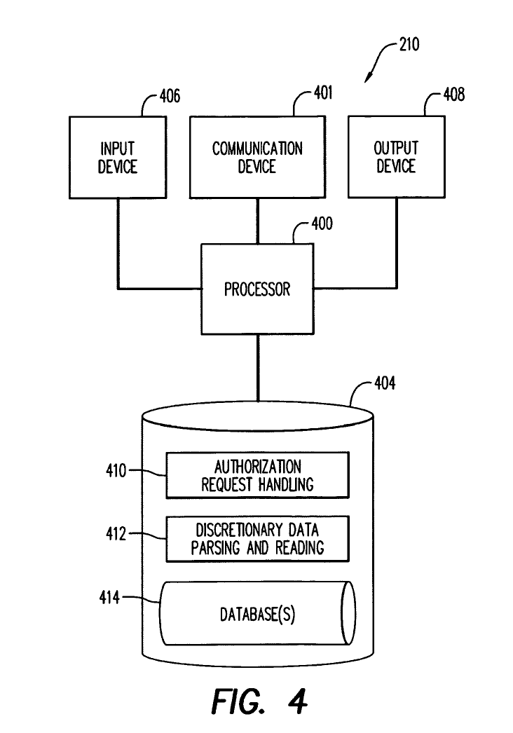

FIG. 4 is a block diagram representation of a server computer that may, for example, function as the issuer server computer 210 shown in FIG. 2.

The issuer server computer 210 may be conventional in its hardware aspects but may be controlled by software to cause it to operate in accordance with aspects of the present invention.

The issuer server computer 210 may include a computer processor 400 operatively coupled to a communication device 401, a storage device 404, an input device 406 and an output device 408.

The computer processor 400 may be constituted by one or more conventional processors. Processor 400 operates to execute processor-executable steps, contained in program instructions described below, so as to control the issuer server computer 210 to provide desired functionality.

Communication device 401 may be used to facilitate communication with, for example, other devices (such as payment card system 208). Communication device 401 may, for example, have capabilities for engaging in data communication over conventional computer-to-computer data networks.

Input device 406 may comprise one or more of any type of peripheral device typically used to input data into a computer. For example, the input device 406 may include a keyboard and a mouse. Output device 408 may comprise, for example, a display and/or a printer.

Storage device 404 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory.

Storage device 404 stores one or more programs for controlling processor 400. The programs comprise program instructions that contain processor-executable process steps of issuer server computer 210, including, in some cases, process steps that constitute processes provided in accordance with principles of the present invention, as described in more detail below.

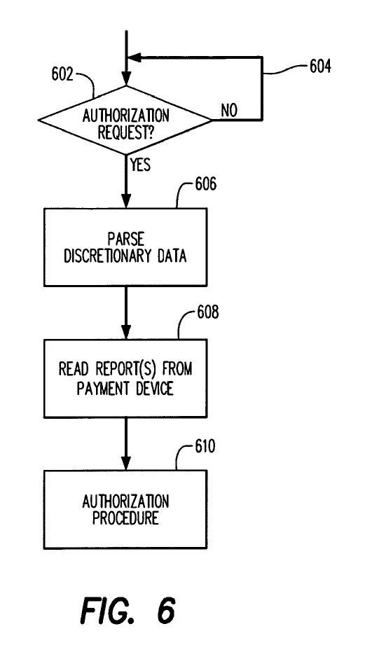

The programs may include an application 410 for receiving and responding to payment system authorization requests in a conventional manner. The storage device 404 may also store an application 412 for receiving information transmitted to the issuer server computer 210 by proximity payment devices via inclusion of such information in a discretionary data field of authorization requests. Details of operation of the application 412 will be discussed hereinbelow, particularly with reference to FIG. 6.

Reference numeral 414 in FIG. 4 identifies one or more databases that are maintained by the issuer server computer 210 on the storage device 404. Among these databases may be a payment card account database, and a database for storing information concerning proximity payment devices that have been personalized to access accounts in the payment card account database.

The application programs of the issuer server computer 210, as described above, may be combined in some embodiments, as convenient, into one, two or more application programs. Moreover, the storage device 404 may store other programs, such as one or more operating systems, device drivers, database management software, web hosting software, etc.

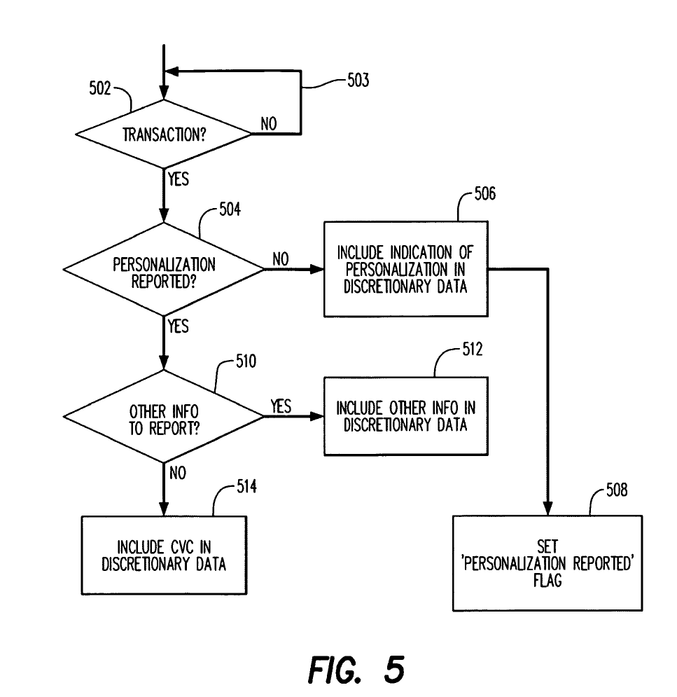

FIG. 5 is a flow chart that illustrates a process that may be performed, in accordance with aspects of the present invention, in the mobile telephone 102. The process illustrated in FIG. 5 may, for example, be embodied in software and/or firmware stored in the payment circuit 324 (FIG.) and/or in the memories 306 of the mobile telephone 102. In at least some cases, the process of FIG. 5 may be embodied in a payment application program that is loaded into the mobile telephone 102 in connection with personalization of the mobile telephone 102.

Referring, then, to FIG. 5, at decision block 502 the mobile telephone 102 determines whether it is being presented to a POS terminal in connection with a purchase transaction. In practice, decision block 502 may simply involve the mobile telephone 102 determining whether it is receiving an interrogation signal from a proximity reader component of a POS terminal. Receipt of an interrogation signal would typically occur when the user of the mobile telephone 102 initiates a purchase transaction by bringing the mobile telephone 102 into proximity with a proximity reader component of a POS terminal.

So long as the mobile telephone 102 is not presented for a purchase transaction, the process of FIG. 502 may idle, as indicated by branch 503. However, if the mobile telephone 102 determines at 502 that it is being presented for a purchase transaction, then decision block 504 may follow 502. At 504, the mobile telephone 102 determines whether it has previously reported that it has been personalized. If the mobile telephone 102 determines at 102 that it has not previously reported that it has been personalized, then block 506 may follow decision block 504.

At block 506, the mobile telephone 102 may include an indicator, to indicate that it has been personalized, in the discretionary data field of Track 1 and/or Track 2 information that it uploads to the POS terminal in connection with the current purchase transaction. Because the indicator regarding personalization of the mobile telephone 102 is included in the discretionary data field of information uploaded to the POS terminal by the mobile telephone 102, the POS terminal, in turn, will include that indicator in the discretionary data field of the authorization request that it initiates. As will be appreciated from the above discussion of FIG. 2, the authorization request will be routed to the issuer computer 210 via the payment system 200 and passing through the acquirer 206 and the payment card system 208. What the issuer computer 210 does with the authorization request will be described below in connection with FIG. 6.

In some embodiments, the authorization request, as initiated by the POS terminal, may include an indication that the transaction originated from proximity-reading a payment device.

In including the personalization indication in the discretionary data field, the mobile telephone 102 may do so by omitting the customary security code, or the mobile telephone 102 may include the personalization indication together with the security code.

Block 508 follows block 506. At block 508, the mobile telephone 102 sets a flag to indicate for future reference that the mobile telephone 102 has already reported its personalization. For example, the flag set at 508 may be referred to in connection with occurrences of decision block 504 in future purchase transactions using the mobile telephone 102.

If at decision block 504 the mobile telephone 102 determines that it has previously reported its personalization, then decision block 510 may follow decision block 504. At decision block 510, the mobile telephone 102 may determine whether it has any other information that should be reported/transmitted to the issuer. Examples of such other information may include: (i) an indication that a payment application program has been loaded into the mobile telephone 102 (the indication or additional information may also identify the application program in question and/or a version number of the application program); (ii) information that identifies the manufacturer of the mobile telephone 102; (iii) information that identifies the version of the operating system that is currently running on the mobile telephone 102; (iv) information that indicates the amount of memory space that is currently unused and available in the mobile telephone 102 for use by the payment application; (v) information that indicates the model number of the mobile telephone 102; and/or (vi) information that indicates what type of device the mobile telephone 102 is (e.g., in this example, an indication that the device in question is a mobile telephone).

This information, or other information inserted by the mobile telephone in the discretionary data field, may be considered report information.

If the mobile telephone 102 determines at 510 that it has other information to report/transmit to the issuer, then block 512 may follow decision block 510. At block 512 the mobile telephone 102 includes some or all of the information in the Track 1 and/or Track 2 discretionary data field that is part of the information uploaded from the mobile telephone 102 to the POS terminal. As was the case with the personalization indication, the information will be included in the discretionary data field of the authorization request and routed to the issuer. In some cases, there may only be room for a portion of the information in the discretionary data field, and accordingly transmission of all the information may be spread over a number of different purchase transactions that may take place over a period of days or weeks.

In some embodiments, the mobile telephone 102 may include a tag or tags, in the uploaded information, to identify the type or types of information included by the mobile telephone 102 in the discretionary data field. Thus a single authorization request may serve to transmit more than one type of information from the payment device to the issuer.

If at decision block 510, the mobile telephone 102 determines that it has no other information to transmit to the issuer, then block 514 may follow decision block 510. At block 514, the mobile telephone 102 may include the security code (e.g., a CVC2or CVC3) in the discretionary data field, in accordance with conventional practices.

In alternative embodiments of the process of FIG. 5, the mobile telephone 102 may include the security code in the discretionary data field along with the personalization indication and/or with the other information described in connection with block 512. In other embodiments of the process of FIG. 5, the mobile telephone 102 may include other information (such as that described in connection with block 512) in the discretionary data field along with the personalization indication referred to in connection with block 506.

FIG. 6 is a flow chart that illustrates a process that may be performed, in accordance with aspects of the present invention, in the issuer computer 210 shown in FIGS. 2 and 4.

The process of FIG. 6 may begin with decision block 602. At decision block 602, the issuer computer 210 may determine whether it has received an authorization request. From previous discussion herein, it will be appreciated that the authorization request may be received from an acquirer 206 (FIG. 2), via the payment card system 208. If no authorization request is received, then the process of FIG. 6 may idle, as indicated at branch 604 in FIG. 6. However, in practice the issuer computer 210 may continuously receive authorization requests and may simultaneously process a considerable number of authorization requests in respective processing threads. Thus FIG. 6 may be considered to represent activities of the issuer computer 210 in connection with a single processing thread among many.

If the issuer computer 210 determines at 602 that an authorization request has been received, then block 606 may follow decision block 602. At block 606, the issuer computer 210 may parse the discretionary data field in the authorization request. As used herein and in the appended claims, the term “parse” refers to analyzing the discretionary data field to determine the contents thereof. If there is information uploaded from a proximity payment device like that described in connection with blocks 506 and/or 512 in FIG. 5, then the issuer computer 210 may read the information, as indicated in block 608 in FIG. 6, and may take suitable action in response to reading the information. For example, the action taken by the issuer computer 210 in response to reading the information from the discretionary data field may include updating a database of information that the issuer computer 210 maintains with respect to payment devices. For example, the issuer computer 210 may update the record in the database for the payment device that initiated the transaction in question.

Apart from parsing and reading the discretionary data field in the authorization request, the issuer computer 210 may handle and respond to the authorization request in a conventional manner, as indicated at 610 in FIG. 6.

As an alternative to having the issuer computer 210 parse and read the information inserted into the discretionary data field by the payment device, another component of the payment system 200 may perform this function. For example, a computer operated by or on behalf of the payment card association may perform this function. This may occur, for example, as part of the payment card association performing “on behalf” services for the issuer. The payment card association may transmit—e.g., by a communication channel which is not shown—batches of information to the issuer to advise the issuer of data received from payment devices via authorization requests.

According to another embodiment of the invention, the issuer may, as an additional security/anti-fraud measure, cause the payment device to require the user to input into the payment device a special PIN (personal identification number) in connection with transactions that are in excess of a certain amount and/or in connection with certain types of transactions. The issuer may store the special PIN in a suitable database, and the payment device may insert the PIN as input by the user into the Track 1 and/or Track 2 discretionary data field as uploaded to the POS terminal. The issuer may then parse and read the discretionary data field to receive the PIN as input by the user in order for the issuer to determine whether to authorize the transaction.

Primarily the above description has referred to the payment device as being a suitably programmed and/or configured, and personalized, mobile telephone. Alternatively, however, the payment device may be a personal digital assistant (PDA)—including devices of the kind referred to as BlackBerrys—or an MP3 player, or any other type of device previously or in future proposed to be operated as a payment device.

As used herein and in the appended claims, the term “security code” refers to a fixed or dynamic CVC or card verification value (CVV) or any similar code stored or generated by a payment device. A security code may be considered to be “generated” by a payment device if the code results from a calculation (e.g., a cryptographic calculation) performed by the device or if merely retrieved from storage within the device.

As used herein and in the appended claims, the term “personalization card” refers to a card-shaped device brought into proximity with another device to personalize the other device for purposes of allowing the other device to engage in payment card system purchase transactions.

As used herein and in the appended claims, the term “payment card association” refers to MasterCard International Incorporated, to Visa, and to any other organization that performs a similar role in a payment system.

The above descriptions of processes herein should not be considered to imply a fixed order for performing the process steps. Rather, the process steps may be performed in any order that is practicable, including simultaneous performance of at least some steps.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving a transaction authorization request in a computer, the transaction authorization request for authorizing a payment card account transaction; and
parsing a discretionary data field defined in the transaction authorization request, to receive information regarding a payment device that initiated the payment card account transaction.

2. The method of claim 1, wherein the information regarding the payment device is information other than or in addition to a security code generated in the payment device.

3. The method of claim 2, wherein the information regarding the payment device is at least one of: (a) a confirmation that the payment device has been personalized; (b) an indication that a payment application program has been loaded into the payment device; (c) information that identifies a manufacturer of the payment device; (d) information that identifies a version of an operating system that runs in the payment device; (e) information that indicates an amount of memory space available, in the payment device, for use by a payment application; (f) information that indicates a model number of the payment device; (g) information that indicates a type of the payment device; and (h) a personal identification number entered into the payment device by a user of the payment device in connection with the payment card account transaction.

4. The method of claim 1, wherein the discretionary data field includes a tag that identifies a type of information included in the discretionary data field.

5. The method of claim 1, wherein the computer is operated by or on behalf of an issuer of payment card accounts.

6. The method of claim 1, wherein the computer is operated by or on behalf of a payment card association.

7. The method of claim 1, wherein the transaction authorization request is received via an acquirer financial institution.

8. The method of claim 1, wherein the transaction authorization request includes a transaction amount and a payment card account number.

9. The method of claim 1, wherein the transaction authorization request includes an indication that the payment card account transaction originated from proximity-reading the payment device.

10. A method comprising:
initiating a purchase transaction by bringing a payment device into proximity with a proximity reader component of a point of sale (POS) terminal; and
the payment device engaging in wireless communication in a predetermined format with the POS terminal, the predetermined format including a discretionary data field, the wireless communication including report information from the payment device in said discretionary data field, said report information indicative of an attribute of the payment device.

11. The method of claim 10, wherein said report information is other than or in addition to a security code generated in the payment device.

12. The method of claim 11, wherein the attribute of the payment device is at least one of (a) a fact that the payment device has been personalized; (b) a payment application program that has been loaded into the payment device; (c) a manufacturer of the payment device; (d) a version of an operating system that runs in the payment device; (e) an amount of memory space available in the payment device for use by a payment application; (f) a model number of the payment device; (g) a type of the payment device; and (h) a personal identification number entered into the payment device by a user of the payment device.

13. The method of claim 10, wherein the payment device uploads to the POS terminal a tag indicative of a type of the report information.

14. The method of claim 10, wherein the payment device is at least one of (a) a mobile telephone; (b) a personal digital assistant; and (c) an MP3 player.

15. A method comprising:
initiating a purchase transaction by bringing a payment device into proximity with a proximity reader component of a point of sale (POS) terminal; and
the payment device transmitting, via the POS terminal, a report that the payment device has been personalized for payment purposes, said report being transmitted by the payment device uploading an indicator to the POS terminal as part of the purchase transaction, the indicator indicative that personalization of the payment device has occurred.

16. The method of claim 15, further comprising:
prior to initiating the purchase transaction, personalizing the payment device by bringing a personalization card into proximity with the payment device.

17. The method of claim 15, further comprising:
prior to initiating the purchase transaction, personalizing the payment device via an over-the-air personalization process.

18. The method of claim 15, wherein the payment device is at least one of (a) a mobile telephone; (b) a personal digital assistant; and (c) an MP3 player.
